(19) United States
(12) Patent Application Publication
(10) Pub. No.: US 2021/0032392 A1
(43) Pub. Date: Feb. 4, 2021

(54) SEMI-FINISHED PRODUCT ON THE BASIS OF A DUAL CROSSLINKING MECHANISM

(71) Applicant: Covestro Deutschland AG, Leverkusen (DE)

(72) Inventors: Richard Meisenheimer, Köln (DE); Paul Heinz, Leverkusen (DE); Dirk Achten, Leverkusen (DE)

(21) Appl. No.: 16/964,367

(22) PCT Filed: Nov. 14, 2018
(86) PCT No.: PCT/EP2018/081161

§ 371 Date: Jul. 23, 2020

(30) Foreign Application Priority Data
Nov. 14, 2017 (EP) PCT/EP2017/079208
Nov. 14, 2017 (EP) PCT/EP2017/079209
Nov. 14, 2017 (EP) PCT/EP2017/079218
May 17, 2018 (EP) 18173040.9

(51) Int. Cl. C08F 290/06; C08J 5/24; C08G 18/09; C08G 18/79; C08G 18/18; C08G 18/22

(52) U.S. Cl. CPC C08F 290/067; C08J 5/24; C08G 18/092; C08J 2375/04; C08G 18/1825; C08G 18/225; C08G 18/792

(57) ABSTRACT

The present invention relates to semi-finished products which are obtained from a reaction mixture that contains ethylenic double bonds and isocyanate groups by radical polymerization of the ethylenic double bonds. The semi-finished product can be converted to an isocyanurate plastic having advantageous properties by carrying out polyaddition polymerization reactions of the isocyanate groups.

The present invention relates to semifinished products obtained from a reaction mixture containing ethylenic double bonds and isocyanate groups by free-radical polymerization of ethylenic double bonds. The semifinished product may be converted into an isocyanurate plastic having advantageous properties by polyaddition reactions of the isocyanate groups.

Plastics obtainable by crosslinking of isocyanate groups with one another are in principle known in the prior art (WO 2015/166983; WO 2016/170059; European Polymer Journal (1980) 16: 147-148). Composite materials containing such plastics as a matrix are disclosed in 2017/191175.

The prior art has not hitherto described any semifinished products that obtain their final mechanical strength and their good chemical resistance primarily through crosslinking of isocyanate groups with one another.

In a first embodiment, the present invention relates to a process for producing a semifinished product containing the steps of
a) wetting a fiber with a reaction mixture having a molar ratio of isocyanate groups to isocyanate-reactive groups of at least 2:1 which contains
   (i) an isocyanate component A;
   (ii) at least one trimerization catalyst C; and
   (iii) at least one component selected from the group consisting of components B, D and E, wherein
   component B has at least one ethylenic double bond but no isocyanate-reactive group;
   component D has at least one isocyanate-reactive group and at least one ethylenic double bond in one molecule; and
   component E has both at least one isocyanate group and at least one ethylenic double bond in one molecule; and
b) free-radical polymerization of at least 50% of the double bonds present in the reaction mixture, thus increasing the viscosity of the reaction mixture by at least 100%.

A “reaction mixture” is a mixture that may be cured by a combination of free-radical polymerization and crosslinking of the isocyanate groups of the isocyanate component with one another to afford a high-strength material. The components A to E defined hereinbelow are essential or optional constituents of the reaction mixture.

The isocyanate component A makes it possible to form a polymer which results from the addition of isocyanate groups. This forms isocyanurate groups in particular. The crosslinking of the isocyanate groups present in the isocyanate component A endows the polymer with the majority of its mechanical and chemical stability. The crosslinking of the isocyanate groups is mediated by the trimerization catalyst C.

The molar ratio of isocyanate groups to isocyanate-reactive groups in the reaction mixture is preferably at least 3:1, more preferably at least 5:1, yet more preferably at least 10:1 and particularly preferably at least 25:1.

Components B, D and E are each characterized by the presence of an ethylenic double bond. This double bond is a prerequisite for a second crosslinking mechanism to be available in addition to the polyaddition of the isocyanate groups in the polymerizable composition.

The present invention is based on the concept of using a reaction mixture which is curable by two different and separately inducible crosslinking mechanisms to provide an already stable semifinished product which may be converted into an end product in a further processing step. The ethylenic double bonds in the compounds B, D and E are used to fix the reaction mixture to the fiber by free-radical polymerization such that the correspondingly treated fibers may be transported and processed, in particular subjected to forming, without the reaction mixture dripping from the fiber. In a particularly preferred embodiment, the coated fiber is tack-free after free-radical polymerization has occured. A reaction mixture whose crosslinking is based only on the free-radical polymerization of the ethylenic double bonds is not suitable for obtaining high-strength plastics in the context of the invention. The high hardness and chemical resistance of the end product obtainable from the semifinished product according to the invention is based substantially on the polyaddition of the isocyanate groups that are present in the reaction mixture. It is therefore necessary according to the invention to limit the proportion of the components B, D and E in the reaction mixture to a value that makes it possible to produce a semifinished product meeting the abovementioned requirements. This allows the proportion of the polyisocyanate component A responsible for the good properties of the end product obtainable from the semifinished product to be maximized.

Accordingly the proportion of the sum of the components B, D and E in the reaction mixture is chosen such that the free-radical polymerization of at least 50 mol % of the ethylenic double bonds present in the reaction mixture is sufficient to increase the viscosity of the reaction mixture by at least 100%, preferably at least 1000% and more preferably at least 10 000%. The proportion of the sum of the components B, D and E in the reaction mixture preferably has an upper limit which is not more than 70% by weight, preferably not more than 60% by weight, particularly preferably not more than 50% by weight, very particularly preferably not more than 40% by weight of the reaction mixture. The reaction mixture preferably has a weight fraction of isocyanate groups in the reaction mixture of at least 1% and not more than 50%.

The proportion of the sum of the components B, D and E in the reaction mixture is particularly preferably chosen such that the free-radical polymerization of at least 50 mol %, preferably at least 70 mol %, particularly preferably at least 80 mol % and very particularly preferably at least 90 mol %, of the ethylenic double bonds present in the reaction mixture has the result that the reaction mixture exceeds the gel point, wherein the gel point is herein defined as the point where G′ becomes greater than G″ as determined by a plate/plate rheometer according to ISO 6721-10:2015-09 at a frequency of 1/s at 23° C.

It is very particularly preferable when the proportion of the sum of the components B, D and E in the reaction mixture is chosen such that the free-radical polymerization of at least 50 mol %, preferably at least 70 mol %, particularly preferably at least 80 mol % and very particularly preferably at least 90 mol % of the ethylenic double bonds present in the reaction mixture has the result that the layer forming on the fiber is tack-free. A tack-free coating is in particular characterized by a modulus G′ determined by a plate/plate rheometer according to ISO 6721-10:2015-09 at a frequency of 1/s at 23° C. of at least 1*10⁵ Pa, preferably 5*10⁵ Pa and particularly preferably 1*10⁶ Pa.

In a particularly preferred embodiment, the minimum proportion of ethylenically unsaturated double bonds in the reaction mixture is 1% by weight, preferably 2% by weight, more preferably 4% by weight and most preferably 6% by weight. In compliance with the abovementioned minimum proportion, the maximum proportion of ethylenically saturated double bonds is 30% by weight, preferably 25% by weight, more preferably 20% by weight and most preferably 15% by weight.

In a further particularly preferred embodiment, ethylenically unsaturated double bonds without isocyanate-reactive functionality are present in the reaction mixture alongside ethylenically unsaturated groups with isocyanate-reactive functionality in a molar ratio of at least 1:5 and not more than 100:1, preferably at least 2:1 and not more than 75:1, particularly preferably at least 1:1 and not more than 50:1 and very particularly preferably at least 5:1 and not more than 25:1. In a further preferred embodiment, the viscosity of the reaction mixture is chosen such that even dense and fine-fiber fiber mats, fiber fabrics and fiber non-crimp fabrics are well wetted by the reaction mixture without the layer formed on the fiber by the reaction mixture becoming thin enough for the reaction mixture to flow through the fibrous fillers without resistance. The viscosity is preferably set to a range from 50 to 50 000 mPas, preferably 100 to 30 000 mPas and particularly preferably 200 to 20 000 mPas through mixing of polyisocyanates which tend to have higher viscosities and low-viscosity compounds having ethylenically unsaturated double bonds.

Isocyanate Component A

“Isocyanate component A” in the context of the invention refers to the isocyanate component in the reactive resin. In other words, this is the sum total of all the compounds in the reactive resin that have isocyanate groups with the exception of component E. The isocyanate component A is thus employed as a reactant in the process according to the invention. When reference is made here to “isocyanate component A”, especially to “providing the isocyanate component A”, this means that the isocyanate component A exists and is used as reactant. The isocyanate component A preferably contains at least one polyisocyanate.

The term “polyisocyanate” as used here is a collective term for compounds containing two or more isocyanate groups in the molecule (this is understood by the person skilled in the art to mean free isocyanate groups of the general structure —N═C═O). The simplest and most important representatives of these polyisocyanates are the diisocyanates. These have the general structure O═C═N—R—N═C═O where R typically represents aliphatic, alicyclic and/or aromatic radicals.

Because of the polyfunctionality (≥2 isocyanate groups), it is possible to use polyisocyanates to produce a multitude of polymers (e.g. polyurethanes, polyureas and polyisocyanurates) and low molecular weight compounds (for example those having uretdione, isocyanurate, allophanate, biuret, iminooxadiazinedione and/or oxadiazinetrione structure).

The term “polyisocyanates” in this application refers equally to monomeric and/or oligomeric polyisocyanates. For the understanding of many aspects of the invention, however, it is important to distinguish between monomeric diisocyanates and oligomeric polyisocyanates. Where reference is made in this application to “oligomeric polyisocyanates”, this means polyisocyanates formed from at least two monomeric diisocyanate molecules, i.e. compounds that constitute or contain a reaction product formed from at least two monomeric diisocyanate molecules.

The production of oligomeric polyisocyanates from monomeric diisocyanates is here also referred to as modification of monomeric diisocyanates. This “modification” as used here means the reaction of monomeric diisocyanates to give oligomeric polyisocyanates having uretdione, isocyanurate, allophanate, biuret, iminooxadiazinedione and/or oxadiazinetrione structure.

For example, hexamethylene diisocyanate (HDI) is a “monomeric diisocyanate” since it contains two isocyanate groups and is not a reaction product of at least two polyisocyanate molecules:

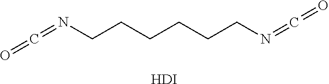

Reaction products which are formed from at least two HDI molecules and still have at least two isocyanate groups, by contrast, are “oligomeric polyisocyanates” within the context of the invention. Proceeding from monomeric HDI, representatives of such “oligomeric polyisocyanates” include for example HDI isocyanurate and HDI biuret which are each constructed from three monomeric HDI units:

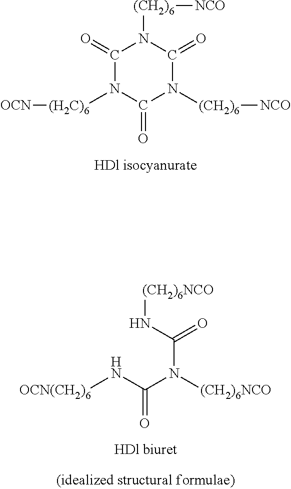

According to the invention, the proportion by weight of isocyanate groups based on the total amount of the isocyanate component A is at least 15% by weight.

In principle, monomeric and oligomeric polyisocyanates are equally suitable for use in the isocyanate component A of the invention. Consequently, the isocyanate component A may consist essentially of monomeric polyisocyanates or essentially of oligomeric polyisocyanates. It may alternatively also comprise oligomeric and monomeric polyisocyanates in any desired mixing ratios.

In a preferred embodiment of the invention, the isocyanate component A used as reactant in the trimerization has a low level of monomers (i.e. a low level of monomeric diisocyanates) and already contains oligomeric polyisocyanates. The expressions “having a low level of monomers” and “having a low level of monomeric diisocyanates” are used here synonymously in relation to the isocyanate component A.

Results of particular practical relevance are established when the isocyanate component A has a proportion of monomeric diisocyanates in the isocyanate component A of not more than 20% by weight, especially not more than 15% by weight or not more than 10% by weight, based in each case on the weight of the isocyanate component A. It is preferable when the isocyanate component A has a content of monomeric diisocyanates of not more than 5% by weight, preferably not more than 2.0% by weight, more preferably not more than 1.0% by weight, based in each case on the weight of the isocyanate component A. Particularly good results are established when the isocyanate component A is essentially free of monomeric diisocyanates. “Essentially free” here means that the content of monomeric diisocyanates is not more than 0.5% by weight, based on the weight of the isocyanate component A.

In a particularly preferred embodiment of the invention, the isocyanate component A consists entirely or to an extent of at least 80%, 85%, 90%, 95%, 98%, 99% or 99.5% by weight, based in each case on the weight of the isocyanate component A, of oligomeric polyisocyanates. Preference is given here to a content of oligomeric polyisocyanates of at least 99% by weight. This content of oligomeric polyisocyanates relates to the isocyanate component A as provided. In other words, the oligomeric polyisocyanates are not formed as intermediate during the process of the invention, but are already present in the isocyanate component A used as reactant on commencement of the reaction.

Polyisocyanate compositions which have a low level of monomers or are essentially free of monomeric isocyanates can be obtained by conducting, after the actual modification reaction, in each case, at least one further process step for removal of the unconverted excess monomeric diisocyanates. This removal of monomers can be effected in a particularly practical manner by processes known per se, preferably by thin-film distillation under high vacuum or by extraction with suitable solvents that are inert toward isocyanate groups, for example aliphatic or cycloaliphatic hydrocarbons such as pentane, hexane, heptane, cyclopentane or cyclohexane.

In a preferred embodiment of the invention, the isocyanate component A of the invention is obtained by modifying monomeric diisocyanates with subsequent removal of unconverted monomers.

In a particular embodiment of the invention, an isocyanate component A having a low level of monomers, however, contains an outside monomeric diisocyanate. In this context, “outside monomeric diisocyanate” means that it differs from the monomeric diisocyanates which have been used for production of the oligomeric polyisocyanates present in the isocyanate component A.

An addition of outside monomeric diisocyanate may be advantageous for achieving specific technical effects, for example a particular hardness. Results of particular practical relevance are established when the isocyanate component A has a proportion of outside monomeric diisocyanate in the isocyanate component A of not more than 20% by weight, especially not more than 15% by weight or not more than 10% by weight, based in each case on the weight of the isocyanate component A. It is preferable when the isocyanate component A has a content of outside monomeric diisocyanate of not more than 5% by weight, especially not more than 2.0% by weight, more preferably not more than 1.0% by weight, based in each case on the weight of the isocyanate component A.

In a further particular embodiment of the process of the invention, the isocyanate component A contains monomeric monoisocyanates or monomeric isocyanates having an isocyanate functionality greater than two, i.e. having more than two isocyanate groups per molecule. The addition of monomeric monoisocyanates or monomeric isocyanates having an isocyanate functionality greater than two has been found to be advantageous in order to influence the network density of the coating. Results of particular practical relevance are established when the isocyanate component A has a proportion of monomeric monoisocyanates or monomeric isocyanates having an isocyanate functionality greater than two in the isocyanate component A of not more than 20% by weight, especially not more than 15% by weight or not more than 10% by weight, based in each case on the weight of the isocyanate component A. It is preferable when the isocyanate component A has a content of monomeric monoisocyanates or monomeric isocyanates having an isocyanate functionality greater than two of not more than 5% by weight, preferably not more than 2.0% by weight, more preferably not more than 1.0% by weight, based in each case on the weight of the isocyanate component A. It is preferable when no monomeric monoisocyanate or monomeric isocyanate having an isocyanate functionality greater than two is used in the trimerization reaction according to the invention.

According to the invention, the oligomeric polyisocyanates may in particular have uretdione, isocyanurate, allophanate, biuret, iminooxadiazinedione and/or oxadiazinetrione structure. In one embodiment of the invention, the oligomeric polyisocyanates have at least one of the following oligomeric structure types or mixtures thereof:

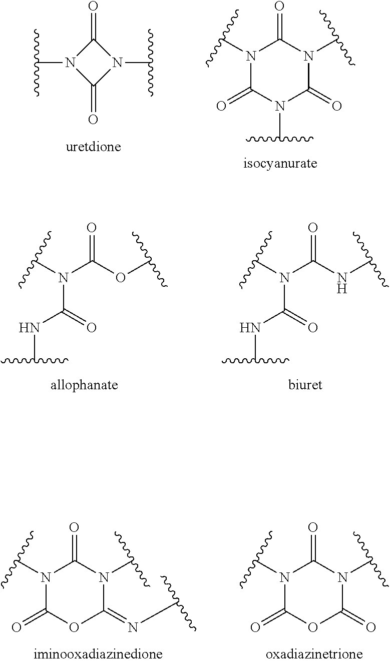 [SMILES: *N1C(=O)N(*)C1=O ; *n1c(=O)n(*)c(=O)n(*)c1=O ; *NC(=O)N(*)C(=O)O* ; *NC(=O)N(*)C(=O)N* ; */N=c1/oc(=O)n(*)c(=O)n1* ; *n1c(=O)oc(=O)n(*)c1=O]

In a preferred embodiment of the invention, an isocyanate component A is employed whose isocyanurate structure proportion is at least 50 mol %, preferably at least 60 mol %, more preferably at least 70 mol %, yet more preferably at least 80 mol %, yet still more preferably at least 90 mol % and especially preferably at least 95 mol % based on the sum of the oligomeric structures from the group consisting of uretdione, isocyanurate, allophanate, biuret, iminooxadiazinedione and oxadiazinetrione structure present in the isocyanate component A.

In a further preferred embodiment of the invention the process according to the invention employs an isocyanate component A containing not only the isocyanurate structure but also at least one further oligomeric polyisocyanate having a uretdione, biuret, allophanate, iminooxadiazinedione and oxadiazinetrione structure and mixtures thereof.

The proportions of uretdione, isocyanurate, allophanate, biuret, iminooxadiazinedione and/or oxadiazinetrione structure in the isocyanate component A can be determined, for example, by NMR spectroscopy. Preferably employable here is 13C NMR spectroscopy, preferably in proton-decoupled form, since the oligomeric structures mentioned give characteristic signals.

Irrespective of the underlying oligomeric structure (uretdione, isocyanurate, allophanate, biuret, iminooxadiazinedione and/or oxadiazinetrione structure), an oligomeric isocyanate component A for use in the process of the invention and/or the oligomeric polyisocyanates present therein preferably have/has an (average) NCO functionality of 2.0 to 5.0, preferably of 2.3 to 4.5.

Results of particular practical relevance are established when the isocyanate component A to be used in accordance with the invention has a content of isocyanate groups of 8.0% to 28.0% by weight, preferably of 14.0% to 25.0% by weight, based in each case on the weight of the isocyanate component A.

Production processes for the oligomeric polyisocyanates having a uretdione, isocyanurate, allophanate, biuret, iminooxadiazinedione and/or oxadiazinetrione structure for use in the isocyanate component A according to the invention are described, for example, in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053 and DE-A 3 928 503 or in EP-A 0 336 205, EP-A 0 339 396 and EP-A 0 798 299.

In an additional or alternative embodiment of the invention, the isocyanate component A of the invention is defined in that it contains oligomeric polyisocyanates which have been obtained from monomeric diisocyanates, irrespective of the nature of the modification reaction used, with observation of an oligomerization level of 5% to 45%, preferably 10% to 40%, more preferably 15% to 30%. “Oligomerization level” is understood here to mean the percentage of isocyanate groups originally present in the starting mixture which are consumed during the production process to form uretdione, isocyanurate, allophanate, biuret, iminooxadiazinedione and/or oxadiazinetrione structures.

Suitable polyisocyanates for production of the isocyanate component A for use in the process of the invention and the monomeric and/or oligomeric polyisocyanates present therein are any desired polyisocyanates obtainable in various ways, for example by phosgenation in the liquid or gas phase or by a phosgene-free route, for example by thermal urethane cleavage. Particularly good results are established when the polyisocyanates are monomeric diisocyanates. Preferred monomeric diisocyanates are those having a molecular weight in the range from 140 to 400 g/mol, having aliphatically, cycloaliphatically, araliphatically and/or aromatically bonded isocyanate groups, for example 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H12MDI), 1,3- and 1,4-bis(isocyanatomethyl)cyclohexane, bis(isocyanatomethyl)norbornane (NBDI), 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetra methyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene (xylylene diisocyanate; XDI), 1,3- and 1,4-bis(1-isocyanato-1-methylethyl)benzene (TMXDI) and bis(4-(1-isocyanato-1-methylethyl)phenyl) carbonate, 2,4- and 2,6-diisocyanatotoluene (TDI), 2,4′- and 4,4′-diisocyanatodiphenylmethane (MDI), 1,5-diisocyanatonaphthalene and any desired mixtures of such diisocyanates. Further diisocyanates which are likewise suitable are additionally found, for example, in Justus Liebigs Annalen der Chemie Volume 562 (1949) p. 75-136.

Suitable monomeric monoisocyanates which can optionally be used in the isocyanate component A are, for example, n-butyl isocyanate, n-amyl isocyanate, n-hexyl isocyanate, n-heptyl isocyanate, n-octyl isocyanate, undecyl isocyanate, dodecyl isocyanate, tetradecyl isocyanate, cetyl isocyanate, stearyl isocyanate, cyclopentyl isocyanate, cyclohexyl isocyanate, 3- or 4-methylcyclohexyl isocyanate or any desired mixtures of such monoisocyanates. An example of a monomeric isocyanate having an isocyanate functionality greater than two which can optionally be added to the isocyanate component A is 4-isocyanatomethyloctane 1,8-diisocyanate (triisocyanatononane; TIN).

In one embodiment of the invention, the isocyanate component A contains not more than 30% by weight, especially not more than 20% by weight, not more than 15% by weight, not more than 10% by weight, not more than 5% by weight or not more than 1% by weight, based in each case on the weight of the isocyanate component A, of aromatic polyisocyanates. As used here, “aromatic polyisocyanate” means a polyisocyanate having at least one aromatically bonded isocyanate group.

Aromatically bonded isocyanate groups are understood to mean isocyanate groups bonded to an aromatic hydrocarbyl radical.

In a preferred embodiment of the process of the invention, an isocyanate component A having exclusively aliphatically and/or cycloaliphatically bonded isocyanate groups is used.

Aliphatically and cycloaliphatically bonded isocyanate groups are respectively understood to mean isocyanate groups bonded to an aliphatic and cycloaliphatic hydrocarbyl radical.

In another preferred embodiment of the process of the invention, an isocyanate component A consisting of or comprising one or more oligomeric polyisocyanates is used, where the one or more oligomeric polyisocyanates have exclusively aliphatically and/or cycloaliphatically bonded isocyanate groups.

In a further embodiment of the invention, the isocyanate component A consists to an extent of at least 70%, 80%, 85%, 90%, 95%, 98% or 99% by weight, based in each case on the weight of the isocyanate component A, of polyisocyanates having exclusively aliphatically and/or cycloaliphatically bonded isocyanate groups. Practical experiments have shown that particularly good results can be achieved with isocyanate component A in which the oligomeric polyisocyanates present therein have exclusively aliphatically and/or cycloaliphatically bonded isocyanate groups.

In a particularly preferred embodiment of the process of the invention, a polyisocyanate composition A is used which consists of or comprises one or more oligomeric polyisocyanates, where the one or more oligomeric polyisocyanates is/are based on 1,4-diisocyanatobutane (BDI), 1,5-diisocyanatopentane (PDI), 1,6-diisocyanatohexane (HDI), isophorone diisocyanate (IPDI) or 4,4′-diisocyanatodicyclohexylmethane (H12MDI) or mixtures thereof.

In a further embodiment of the invention, the process according to the invention employs isocyanate components A having a viscosity greater than 500 mPas and less than 200 000 mPas, preferably greater than 1000 mPas and less than 100 000 mPas, more preferably greater than 1000 mPas and less than 50 000 mPas and yet more preferably greater than 1000 mPas and less than 25 000 mPas, measured according to DIN EN ISO 3219 at 21° C.

Component B

Suitable components B are all compounds containing at least one ethylenic double bond. This ethylenic double bond is crosslinkable with other ethylenic double bonds by a free-radical reaction mechanism. This condition is met by preferably activated double bonds between the a carbon atom and the 13 carbon atom alongside an activating group. The activating group is preferably a carboxyl or carbonyl group. Most preferably, component B is an acrylate, a methacrylate, the ester of an acrylate or the ester of a methacrylate. Preferably, component B does not contain any isocyanate-reactive groups as defined further up in this application.

Preferred components B are components B1 with one, components B2 with two and components B3 with three of the above-described ethylenic double bonds. Particular preference is given to B1 and/or B2.

In a preferred embodiment, component B used is a mixture of at least one component B1 and at least one component B2.

In a further preferred embodiment, component B used is a mixture of at least one component B1 and at least one component B3.

In yet a further preferred embodiment, component B used is a mixture of at least one component B2 and at least one component B3.

In yet a further preferred embodiment, component B used is a mixture of at least one component B1, at least component B2 and at least one component B3. Preference is given to using a mixture of at least one component B1 with at least one component B2. The mass ratio of components B1 and B2 is preferably between 30:1 and 1:30, more preferably between 20:1 and 1:20, yet more preferably between 1:10 and 10:1 and most preferably between 2:1 and 1:2.

Preferred components B1 are methyl (meth)acrylate, ethyl (meth)acrylate, propyl (meth)acrylate, isopropyl (meth)acrylate, butyl (meth)acrylate, isobutyl (meth)acrylate, tert-butyl (meth)acrylate, hexyl (meth)acrylate, heptyl (meth)acrylate, 2-ethylhexyl (meth)acrylate, cyclohexyl (meth)acrylate, octyl (meth)acrylate, isooctyl (meth)acrylate, decyl (meth)acrylate, benzyl (meth)acrylate, tetrahydrofurfuryl (meth)acrylate, octadecyl (meth)acrylate, dodecyl (meth)acrylate, tetradecyl (meth)acrylate, oleyl (meth)acrylate, 4-methylphenyl (meth)acrylate, benzyl (meth)acrylate, furfuryl (meth)acrylate, cetyl (meth)acrylate, 2-phenylethyl (meth)acrylate, isobornyl (meth)acrylate, neopentyl (meth)acrylate, methacrylamide and n-isopropylmethacrylamide.

Preferred components B2 are vinyl (meth)acrylate, tetraethylene glycol di(meth)acrylate, dipropylene glycol di(meth)acrylate, hexane-1,6-diol di(meth)acrylate, neopentyl glycol propoxylate di(meth)acrylate, tripropylene glycol di(meth)acrylate, bisphenol A ethoxylated di(meth)acrylate, ethylene glycol di(meth)acrylate, propylene glycol di(meth)acrylate, neopentyl glycol di(meth)acrylate, hexamethylene glycol di(meth)acrylate, bisphenol A di(meth)acrylate and 4,4′-bis(2-(meth)acryloyloxyethoxy)diphenylpropane.

Preferred components B3 are ethoxylated trimethylolpropane tri(meth)acrylate, propoxylated glycerol tri(meth)acrylate, pentaerythritol tri(meth)acrylate, trimethylolpropane ethoxytri(meth)acrylate, trimethylolpropane tri(meth)acrylate, alkoxylated tri(meth)acrylate and tris(2-(meth)acryloylethyl) isocyanurate.

Trimerization Catalyst C

The trimerization catalyst C may be mixed from one catalyst type or different catalyst types, but contains at least one catalyst that brings about the trimerization of isocyanate groups to isocyanurates or iminooxadiazinediones.

Suitable catalysts for the process of the invention are, for example, simple tertiary amines, for example triethylamine, tributylamine, N,N-dimethylaniline, N-ethylpiperidine or N,N′-dimethylpiperazine. Suitable catalysts also include the tertiary hydroxyalkylamines described in GB 2 221 465, for example triethanolamine, N-methyldiethanolamine, dimethylethanolamine, N-isopropyldiethanolamine and 1-(2-hydroxyethyl)pyrrolidine or the catalyst systems known from GB 2 222 161 that consist of mixtures of tertiary bicyclic amines, for example DBU, with simple aliphatic alcohols of low molecular weight.

Likewise suitable as trimerization catalysts for the process of the invention are a multitude of different metal compounds. Suitable examples are the octoates and naphthenates of manganese, iron, cobalt, nickel, copper, zinc, zirconium, cerium or lead or mixtures thereof with acetates of lithium, sodium, potassium, calcium or barium that are described as catalysts in DE-A 3 240 613, the sodium and potassium salts of linear or branched alkanecarboxylic acids having up to 10 carbon atoms that are disclosed by DE-A 3 219 608, such as of propionic acid, butyric acid, valeric acid, caproic acid, heptanoic acid, caprylic acid, pelargonic acid, capric acid and undecyl acid, the alkali metal or alkaline earth metal salts of aliphatic, cycloaliphatic or aromatic mono- and polycarboxylic acids having 2 to 20 carbon atoms that are disclosed by EP-A 0 100 129, such as sodium benzoate or potassium benzoate, the alkali metal phenoxides disclosed by GB-PS 1 391 066 and GB-PS 1 386 399, such as sodium phenoxide or potassium phenoxide, the alkali metal and alkaline earth metal oxides, hydroxides, carbonates, alkoxides and phenoxides disclosed by GB 809 809, alkali metal salts of enolizable compounds and metal salts of weak aliphatic or cycloaliphatic carboxylic acids such as sodium methoxide, sodium acetate, potassium acetate, sodium acetoacetate, lead 2-ethylhexanoate, and lead naphthenate, the basic alkali metal compounds complexed with crown ethers or polyether alcohols that are disclosed by EP-A 0 056 158 and EP-A 0 056 159, such as complexed sodium carboxylates or potassium carboxylates, the pyrrolidinone potassium salt disclosed by EP-A 0 033 581, the mono- or polynuclear complex compound of titanium, zirconium and/or hafnium disclosed by application EP 13196508.9, such as zirconium tetra-n-butoxide, zirconium tetra-2-ethylhexanoate and zirconium tetra-2-ethylhexoxide, and tin compounds of the type described in European Polymer Journal, vol. 16, 147-148 (1979), such as dibutyltin dichloride, diphenyltin dichloride, triphenylstannanol, tributyltin acetate, tributyltin oxide, tin dioctoate, dibutyl(dimethoxy)stannane, and tributyltin imidazolate.

Further trimerization catalysts suitable for the process of the invention are, for example, the quaternary ammonium hydroxides known from DE-A 1 667 309, EP-A 0 013 880 and EP-A 0 047 452, for example tetraethylammonium hydroxide, trimethylbenzylammonium hydroxide, N,N-dimethyl-N-dodecyl-N-(2-hydroxyethyl)ammonium hydroxide, N-(2-hydroxyethyl)-N,N-dimethyl-N-(2,2′-dihydroxymethylbutyl)ammonium hydroxide and 1-(2-hydroxyethyl)-1,4-diazabicyclo[2.2.2]octane hydroxide (monoadduct of ethylene oxide and water onto 1,4-diazabicyclo[2.2.2]octane), the quaternary hydroxyalkylammonium hydroxides known from EP-A 37 65 or EP-A 10 589, for example N,N,N-trimethyl-N-(2-hydroxyethyl)ammonium hydroxide, the trialkylhydroxylalkylammonium carboxylates that are known from DE-A 2631733, EP-A 0 671 426, EP-A 1 599 526 and U.S. Pat. No. 4,789,705, for example N,N,N-trimethyl-N-2-hydroxypropylammonium p-tert-butylbenzoate and N,N,N-trimethyl-N-2-hydroxypropylammonium 2-ethylhexanoate, the quaternary benzylammonium carboxylates known from EP-A 1 229 016, for example N-benzyl-N,N-dimethyl-N-ethylammonium pivalate, N-benzyl-N,N-dimethyl-N-ethylammonium 2-ethylhexanoate, N-benzyl-N,N,N-tributylammonium 2-ethylhexanoate, N,N-dimethyl-N-ethyl-N-(4-methoxybenzyl)ammonium 2-ethylhexanoate or N,N,N-tributyl-N-(4-methoxybenzyl)ammonium pivalate, the tetrasubstituted ammonium α-hydroxycarboxylates known from WO 2005/087828, for example tetramethylammonium lactate, the quaternary ammonium or phosphonium fluorides known from EP-A 0 339 396, EP-A 0 379 914 and EP-A 0 443 167, for example N-methyl-N,N,N-trialkylammonium fluorides with C8-C10-alkyl radicals, N,N,N,N-tetra-n-butylammonium fluoride, N,N,N-trimethyl-N-benzylammonium fluoride, tetramethylphosphonium fluoride, tetraethylphosphonium fluoride or tetra-n-butylphosphonium fluoride, the quaternary ammonium and phosphonium polyfluorides known from EP-A 0 798 299, EP-A 0 896 009 and EP-A 0 962 455, for example benzyltrimethylammonium hydrogen polyfluoride, the tetraalkylammonium alkylcarbonates which are known from EP-A 0 668 271 and are obtainable by reaction of tertiary amines with dialkyl carbonates, or betaine-structured quaternary ammonioalkyl carbonates, the quaternary ammonium hydrogencarbonates known from WO 1999/023128, for example choline bicarbonate, the quaternary ammonium salts which are known from EP 0 102 482 and are obtainable from tertiary amines and alkylating esters of phosphorus acids, examples of such salts being reaction products of triethylamine, DABCO or N-methylmorpholine with dimethyl methanephosphonate, or the tetrasubstituted ammonium salts of lactams that are known from WO 2013/167404, for example trioctylammonium caprolactamate or dodecyltrimethylammonium caprolactamate.

Further trimerization catalysts C suitable in accordance with the invention can be found, for example, in J. H. Saunders and K. C. Frisch, Polyurethanes Chemistry and Technology, p. 94 ff. (1962) and the literature cited therein.

Particular preference is given to carboxylates and phenoxides with metal or ammonium ions as counterion. Suitable carboxylates are the anions of all aliphatic or cycloaliphatic carboxylic acids, preferably those with mono- or polycarboxylic acids having 1 to 20 carbon atoms. Suitable metal ions are derived from alkali metals or alkaline earth metals, manganese, iron, cobalt, nickel, copper, zinc, zirconium, cerium, tin, titanium, hafnium or lead. Preferred alkali metals are lithium, sodium and potassium, particularly preferably sodium and potassium. Preferred alkaline earth metals are magnesium, calcium, strontium and barium.

Very particular preference is given to the octoate and naphthenate catalysts described in DE-A 3 240 613, these being octoates and naphthenates of manganese, iron, cobalt, nickel, copper, zinc, zirconium, cerium or lead, or mixtures thereof with acetates of lithium, sodium, potassium, calcium or barium.

Very particular preference is likewise given to sodium benzoate or potassium benzoate, to the alkali metal phenoxides known from GB-PS 1 391 066 and GB-PS 1 386 399, for example sodium phenoxide or potassium phenoxide, and to the alkali metal and alkaline earth metal oxides, hydroxides, carbonates, alkoxides and phenoxides that are known from GB 809 809.

The trimerization catalyst C preferably contains a polyether. This is especially preferred when the catalyst contains metal ions. Preferred polyethers are selected from the group consisting of crown ethers, diethylene glycol, polyethylene glycols and polypropylene glycols. It has been found to be of particular practical relevance in the process of the invention to use a trimerization catalyst B containing, as polyether, a polyethylene glycol or a crown ether, more preferably 18-crown-6 or 15-crown-5. Preferably, the trimerization catalyst B comprises a polyethylene glycol having a number-average molecular weight of 100 to 1000 g/mol, preferably 300 g/mol to 500 g/mol and especially 350 g/mol to 450 g/mol.

Very particular preference is given to the combination of the above-described carboxylates and phenoxides of alkali metals or alkaline earth metals with a polyether.

It has further been found that compounds according to the formula (I) below are particularly suitable as catalysts C

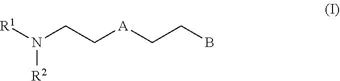

wherein R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl;
A is selected from the group consisting of O, S and NR³ where R³ is selected from the group consisting of hydrogen, methyl, ethyl, propyl, isopropyl, butyl and isobutyl; and
B is independently of A selected from the group consisting of OH, SH NHR⁴ and NH₂, wherein R⁴ is selected from the group consisting of methyl, ethyl and propyl.

In a preferred embodiment, A is NR³, wherein R³ is selected from the group consisting of hydrogen, methyl, ethyl, propyl, isopropyl, butyl and isobutyl. Preferably, R³ is methyl or ethyl. R³ is particularly preferably methyl.
In a first variant of this embodiment, B is OH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.
In a second variant of this embodiment, B is SH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.
In a third variant of this embodiment, B is NHR⁴ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl. In this variant, R4 is selected from the group consisting of methyl, ethyl and propyl. It is preferable when R4 is methyl or ethyl. R⁴ is particularly preferably methyl.
In a fourth variant of this embodiment, B is NH₂ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.

In a further preferred embodiment, A is oxygen.
In a first variant of this embodiment B is OH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.
In a second variant of this embodiment, B is SH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.
In a third variant of this embodiment, B is NHR⁴ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl. In this variant, R⁴ is selected from the group consisting of methyl, ethyl and propyl. It is preferable when R4 is methyl or ethyl. R⁴ is particularly preferably methyl.
In a fourth variant of this embodiment, B is NH₂ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.

In yet a further preferred embodiment, A is sulfur.
In a first variant of this embodiment B is OH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.
In a second variant of this embodiment, B is SH and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.
In a third variant of this embodiment, B is NHR⁴ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl. In this variant, R⁴ is selected from the group consisting of methyl, ethyl and propyl. It is preferable when R4 is methyl or ethyl. R4 is particularly preferably methyl.
In a fourth variant of this embodiment, B is NH₂ and R¹ and R² are independently of one another selected from the group consisting of hydrogen, methyl, ethyl, propyl, isopropyl, butyl, isobutyl, branched C5-alkyl, unbranched C5-alkyl, branched C6-alkyl, unbranched C6-alkyl, branched C7-alkyl and unbranched C7-alkyl. It is preferable when R¹ and R² are independently of one another methyl or ethyl. R¹ and R² are particularly preferably methyl.

Also suitable are adducts of a compound of formula (I) and a compound having at least one isocyanate group.

The umbrella term “adduct” is understood to mean urethane, thiourethane and urea adducts of a compound of formula (I) with a compound having at least one isocyanate group. A urethane adduct is particularly preferred. The adducts according to the invention are formed when an isocyanate reacts with the functional group B of the compound defined in formula (I). When B is a hydroxyl group a urethane adduct is formed. When B is a thiol group a thiourethane adduct is formed. And when B is NH₂ or NHR⁴ a urea adduct is formed.

Component D

Component D is a compound having at least one isocyanate-reactive group as defined further up in this application and at least one ethylenic double bond in one molecule. The isocyanate-reactive group of component D may also be a uretdione group. Ethylenic double bonds are preferably those that are crosslinkable with other ethylenic double bonds by a free-radical reaction mechanism. Corresponding activated double bonds are defined in detail further up in this application for component B.

Preferred components D are alkoxyalkyl (meth)acrylates having 2 to 12 carbon atoms in the hydroxyalkyl radical. Particular preference is given to 2-hydroxyethyl acrylate, the isomer mixture formed on addition of propylene oxide onto acrylic acid, or 4-hydroxybutyl acrylate.

In a preferred embodiment, the isocyanate-reactive group of D preferably reacts prior to or contemporaneously with the reaction of the double bonds in step b. A pre-reaction of the isocyanate-reactive group of D with A is preferred to improve the compatibility of the reaction components after the free-radical polymerization of the double bonds. This is particularly preferred in combination with a small weight fraction of component D of less than 20% by weight, preferably less than 10% by weight, particularly preferably less than 5% by weight, in the reaction mixture since otherwise the viscosity of the reaction mixture can increase in uncontrolled fashion via formation of urethane groups for example.

Component E

Component E is a compound having both at least one isocyanate group and at least one ethylenic double bond in one molecule. It can advantageously be obtained by crosslinking a component D described in the preceding paragraph with a monomeric or oligomeric polyisocyanate as described further up in this application. This crosslinking is effected by reaction of the isocyanate-reactive groups, in this case especially a hydroxyl, amino or thiol group, and an isocyanate group of the polyisocyanate. This is preferably catalyzed by a component G as further down in this application. But any other suitable catalyst known to those skilled in the art is also conceivable. It is also possible to dispense with a catalyst entirely.

Particular preference is given to combinations in which a hexamethylene diisocyanate- or pentamethylene diisocyanate-based oligomeric polyisocyanate is combined with a component D selected from the group consisting of 2-hydroxyethyl acrylate, the isomer mixture formed on addition of propylene oxide onto acrylic acid, and 4-hydroxybutyl acrylate.

Further preferred components E are 2-isocyanatoethyl (meth)acrylate, tris(2-hydroxyethyl) isocyanate tri(meth)acrylate, vinyl isocyanates, allyl isocyanates and 3-isopropenyl-α,α-dimethylbenzyl isocyanate.

Component F

In principle, free-radical polymerization of the ethylenically unsaturated compounds present in the reaction mixture can be brought about by actinic radiation with a sufficient energy content. This is possible especially in the case of gamma radiation, electron radiation, proton radiation and/or UV-VIS radiation in the wavelength range between 200 and 500 nm. In this case, the polymerizable composition of the invention need not contain any component F.

But if the use of corresponding radiation is to be dispensed with, the presence of at least one component F suitable as an initiator for a free-radical polymerization of the ethylenic double bonds present in the polymerizable composition of the invention is required. The effect of initiators of this kind is that they form, under suitable conditions, especially when heated or under the action of suitable radiation, free radicals that react with the ethylenic double bonds, forming vinyl radicals which for their part react with further ethylenic double bonds in a chain reaction. Component F comprises at least one radiation-activated initiator F1 or at least one heat-activated initiator F2. But it may also comprise a mixture of at least one radiation-activated initiator F1 and at least one heat-activated initiator F2.

In a particular embodiment, redox-activated initiators F3 composed of at least one oxidizing agent and one reducing agent are also conceivable. Examples include the combination of iron(II) salts and hydroperoxides or of copper(I) salts and activated organochlorine compounds, for example benzyl chloride.

The use of radiation-activated initiators F1 is in principle preferred since this is the best way to induce free-radical polymerization without also inducing crosslinking of the isocyanate groups. However, it is also possible to use heat-activated initiators F2. This then requires that the the heat-activated initiator F2 and the trimerization catalyst C are chosen such that the trimerization catalyst C does not yet show any substantial activity at the temperature which induces free-radical polymerization. This can be verified by simple preliminary experiments.

When choosing suitable initiators F2 and trimerization catalysts C it must be ensured that there is a temperature difference of at least 5° C., preferably at least 10° C. and very particularly preferably at least 20° C. between the decomposition temperatures of the initiator F2 and the activation temperature of the trimerization catalyst C. In this case “activation temperature” is to be understood as meaning a temperature at which at least 10% of the isocyanate groups are converted within not more than one hour. The conversion of the isocyanate groups may be monitored using ATR-IR spectroscopy via the reduction in the peak height of the isocyanate peak (normalized to the peak height of the CH vibration).

Preferred radiation-activated initiators F1 are compounds of the unimolecular type (I) and of the bimolecular type (II). Examples of suitable type (I) systems are aromatic ketone compounds such as for example benzophenones in combination with tertiary amines, alkylbenzophenones, 4,4′-bis(dimethylamino)benzophenone (Michler's ketone), anthrone, and halogenated benzophenones or mixtures of said types. Also suitable are type (II) initiators such as benzoin and derivatives thereof, benzil ketals, acylphosphine oxides, 2,4,6-trimethylbenzoyldiphenylphosphine oxide, bisacylphosphine oxides, phenylglyoxylic esters, camphorquinone, α-aminoalkylphenones, α,α-dialkoxyacetophenones, and α-hydroxyalkylphenones. Specific examples are Irgacure® 500 (a mixture of benzophenone and 1-hydroxycyclohexyl phenyl ketone, from Ciba, Lampertheim, DE), Irgacure® 819 DW (phenylbis(2,4,6-trimethylbenzoyl)phosphine oxide, from Ciba, Lampertheim, DE) or Esacure® KIP EM (oligo-[2-hydroxy-2-methyl-1-[4-(1-methylvinyl)phenyl]propanones], from Lamberti, Aldizzate, Italy), and bis(4-methoxybenzoyl)diethylgermane. Mixtures of these compounds may also be used.

It needs to be ensured that the photoinitiators have sufficient reactivity with respect to the radiation source used. Numerous commercially available photoinitiators are known. The entire wavelength range of the UV-VIS spectrum is covered by commercially available photoinitiators.

Preferred heat-activated initiators F2 are organic azo compounds, organic peroxides and C—C-cleaving initiators, such as benzpinacol silyl ether, N,N-diacylhydroxylamines, O-alkylated N,N-diacylhydroxylamines or O-acylated N,N-diacylhydroxylamines. Likewise suitable are inorganic peroxides such as peroxodisulfates. Further suitable thermal free-radical initiators are azobisisobutyronitrile (AIBN), dibenzoyl peroxide (DBPO), di-tert-butyl peroxide, dicumyl peroxide (DCP) and tert-butyl peroxybenzoate. However, the person skilled in the art may also use any other thermal initiators familiar to him.

Additives G

In a further embodiment of the present invention the reaction mixture additionally contains at least one additive G selected from the group consisting of pigments, dyes, organic fillers, inorganic fillers, leveling agents and thickeners.

Fiber

The fiber employable according to the invention may be selected from all inorganic fibers, organic fibers, natural fibers or mixtures thereof known to those skilled in the art. Said fiber may contain further substances serving as sizes for example.

Preferred inorganic fibers are glass fibers, basalt fibers, boron fibers, ceramic fibers, whiskers, silica fibers and metallic reinforcing fibers. Preferred organic fibers are aramid fibers, carbon fibers, carbon nanotubes, polyester fibers, polyethylene fibers, nylon fibers and Plexiglass fibers. Preferred natural fibers are flax fibers, hemp fibers, wood fibers, cellulose fibers and sisal fibers.

According to the invention suitable fibers include all fibers having an aspect ratio greater than 1000, preferably greater than 5000, more preferably greater than 10 000 and most preferably greater than 50 000. The aspect ratio is defined as the length of the fibers divided by the diameter. While complying with the above-defined aspect ratio the fibers preferably have a minimum length of 1 m, particularly preferably 50 m and very particularly preferably 100 m. The individual fibers preferably have a diameter of less than 0.1 mm, more preferably less than 0.05 mm, and yet more preferably less than 0.03 mm.

The fibers may be individual fibers but may also have been non-crimp wovens or woven or knitted in any form known to those skilled in the art to afford mats or tiles.

The ratio between the reaction mixture, the fibers and all other constituents of the semifinished product is preferably chosen such that the fiber content is at least 10% by volume, preferably 20% by volume, more preferably at least 30% by volume, yet more preferably at least 40% by volume and most preferably at least 50% by volume of the finished semifinished product.

Wetting of the Fiber

The wetting of the fibers may be carried out using any of the methods known to those skilled in the art that enable good wetting of the fibers with the reaction mixture. Without any claim to completeness, these include bar coating, a dipping bath, an injection box, spraying methods, resin injection methods, resin infusion methods with vacuum or under pressure, an application roll and manual lamination methods.

In a particularly preferred embodiment of the invention, a dipping bath is used. The dried fibers are pulled here through an open resin bath, with deflection of the fibers into and out of the resin bath via guide grids (bath method). Alternatively, the fibers also can be pulled straight through the impregnation device without deflection (pull-through method).

In a further particularly preferred embodiment of the invention, an injection box is used. In the case of the injection box, the fibers are pulled without deflection into the impregnation unit that already has the shape of the later profile. By means of pressure, the reactive resin mixture is pumped into the box, preferably transverse to the fiber direction.

Free-Radical Polymerization

The ethylenic double bonds present in the polymerizable composition of the invention are crosslinked by a free-radical polymerization. If a radiation-activated initiator F1 is present, this polymerization reaction is initiated in accordance with the invention by the use of radiation suitable for activation thereof. If a heat-activated initiator F2 is present in the polymerizable composition used, the crosslinking of the ethylenic double bonds is initiated by heating the polymerizable composition to the temperature required. In principle, however—irrespective of the presence of initiators F1 or F2—the use of sufficiently high-energy radiation as defined hereinabove in this application is also sufficient to initiate the free-radical polymerization.

In any event the obtained semifinished product should preferably be stored under cool conditions at a temperature at which the isocyanate addition reaction proceeds only slowly, if at all. To this end it is advantageous to choose a storage temperature which is at least 10° C., preferably at least 30° C. and very particularly preferably at least 50° C. below the activation temperature of the trimerization catalyst C.

However, in a particular embodiment of the invention, it may be desirable for the conversion of the free-radical double bonds and the isocyanate reaction to be carried out almost contemporaneously. In this case the composition temperature of the reaction mixture/the wetted fiber, non-crimp fabric or woven fabric is adapted such that the free-radical polymerization and the isocyanate addition reaction occur simultaneously.

Semifinished Product

The product of the process according to the invention is a semifinished product. This semifinished product obtainable by the process according to the invention forms the subject matter of a further embodiment of the present invention.

In the context of the present application “semifinished product” is to be understood as meaning that said product already has a geometrically defined shape but only obtains its ultimate strength as a result of a further process step in which the isocyanate groups present in the semifinished product are crosslinked with one another by polyaddition.

Since the reaction mixture in the semifinished product according to the invention has not yet completely cured the semifinished product may be subjected to forming between the free-radical polymerization of the ethylenically unsaturated double bonds and the polyaddition of the isocyanate groups. This may be effected for example by bending or pressing. The forming may also be carried out at commencement of the crosslinking of the isocyanate groups.

Crosslinking of the Isocyanate Groups

The “crosslinking” of the isocyanate component A is a process in which the isocyanate groups present therein react with one another or with urethane groups already present to form at least one structure selected from the group consisting of uretdione, isocyanurate, allophanate, biuret, iminooxadiazinedione and oxadiazinetrione structures. In this reaction, the isocyanate groups originally present in the isocyanate component A are consumed. The formation of the aforementioned groups results in combination of the monomeric and oligomeric polyisocyanates present in the isocyanate component A to form a polymer network.

Since, according to the invention, there is a distinct molar excess of isocyanate groups over isocyanate-reactive groups in the reaction mixture the crosslinking reaction has the result that at the end of the crosslinking not more than 50%, preferably not more than 30%, particularly preferably not more than 10%, very particularly preferably not more than 5% and in particular not more than 3% of the reactive isocyanate groups are present as urethane and/or allophanate groups after conversion. In a particularly preferred embodiment of the invention, the cured isocyanate component A, however, is not entirely free of urethane and allophanate groups. Consequently, taking account of the upper limits defined in the preceding paragraph, it preferably contains at least 0.1% urethane and/or allophanate groups based on the total nitrogen content.

It is preferable when the crosslinking of the isocyanate groups present in the reaction mixture proceeds predominantly via cyclotrimerization of at least 50%, preferably at least 60%, particularly preferably at least 70%, especially at least 80% and very particularly preferably 90% of the free isocyanate groups present in the isocyanate component A to afford isocyanurate structural units. Thus, in the finished material, corresponding proportions of the nitrogen originally present in the isocyanate component A are bound within isocyanurate structures. However, side reactions, especially those to give uretdione, allophanate and/or iminooxadiazinedione structures, typically occur and can even be used in a controlled manner in order to advantageously affect, for example, the glass transition temperature (Tg) of the polyisocyanurate plastic obtained. However, the above-defined content of urethane and/or allophanate groups is preferably present in this embodiment too.

The crosslinking of the isocyanate groups is preferably effected at temperatures between 50° C. and 300° C., more preferably between 80° C. and 250° C. and yet more preferably between 100° C. and 220° C.

During crosslinking of the isocyanate groups the abovementioned temperatures are maintained until at least 50%, preferably at least 75% and yet more preferably at least 90% of the free isocyanate groups present in the semifinished product according to the invention at commencement of the crosslinking of the isocyanate groups is consumed. The percentage of isocyanate groups still present can be determined by a comparison of the content of isocyanate groups in % by weight in the isocyanate component A present at commencement of the crosslinking of the isocyanate groups with the content of isocyanate groups in % by weight in the reaction product, for example by the aforementioned comparison of the intensity of the isocyanate band at about 2270 cm⁻¹ by means of ATR-IR spectroscopy.

The exact duration of the crosslinking of the isocyanate groups naturally depends on the geometry of the workpiece to be created, especially the ratio of surface area and volume, since the required temperature has to be attained for the minimum time required even in the core of the workpiece being formed. The person skilled in the art is able to determine these parameters by simple preliminary tests.

In principle, crosslinking of the abovementioned proportions of free isocyanate groups is achieved when the abovementioned temperatures are maintained for 1 minute to 4 hours. Particular preference is given to a duration between 1 minute and 15 minutes at temperatures between 180° C. and 220° C. or a duration of 5 minutes to 120 minutes at a temperature between 120° C. and 150° C.

The semifinished product according to the invention is storable and transportable. It can therefore be centrally pre-produced and subsequently transported to the locations at which it is to be subjected to further processing. In a preferred embodiment of the present invention, the crosslinking of the isocyanate groups is therefore not carried out at the location at which the semifinished product is produced.

It is preferable when there are at least 10 m, more preferably at least 50 m, yet more preferably at least 500 m and most preferably at least 1000 m between the location at which the semifinished product according to the invention is produced and the location at which the crosslinking of the isocyanate groups present in the semifinished product is performed.

The semifinished product according to the invention is storage stable for days or weeks in the absence of air when the ambient temperature is not more than 60° C., preferably not more than 40° C., particularly preferably not more than 30° C. and very particularly preferably not more than 25° C.

In a particularly preferred embodiment of the present invention, there is a timespan between the production of the semifinished product according to the invention and the crosslinking of the isocyanate groups present therein of 12 hours to 1 year, preferably of two days to 6 months, more preferably 3 days to 3 months and in particular of at least 7 days to 2 months in which the semifinished product is stored at temperatures of not more than 30° C., preferably not more than 20° C. A short-term exceedance of the abovementioned storage temperatures is harmless so long as the combination of extent and duration of the temperature elevation does not lead to a crosslinking of more than 10% of the isocyanate groups present in the semifinished product and the Tg of the semifinished product does not increase by more than 20° C. “Storage” in the context of this patent application includes a change of location, i.e. transport as defined hereinabove.

In a further embodiment the present invention relates to a composite material obtainable by crosslinking the isocyanate groups present in the semifinished product according to the invention.

The working examples which follow serve merely to illustrate the invention. They are not in any way intended to limit the scope of protection of the claims.

### EXAMPLES

General Information:

Unless otherwise stated all reported percentage values are in percent by weight (% by weight).

The ambient temperature of 23° C. at the time of performing the experiments is referred to as RT (room temperature).

The methods detailed hereinafter for determination of the appropriate parameters were used for performance and evaluation of the examples and are also the methods for determination of the parameters of relevance in accordance with the invention in general.

Determination of Phase Transitions by DSC

The phase transitions were determined by means of DSC (differential scanning calorimetry) with a Mettler DSC 12E (Mettler Toledo GmbH, Giessen, Germany) in accordance with DIN EN 61006. Calibration was effected via the melt onset temperature of indium and lead. 10 mg of substance were weighed out in standard capsules. The measurement was effected by three heating runs from −50° C. to +200° C. at a heating rate of 20 K/min with subsequent cooling at a cooling rate of 320 K/min. Cooling was effected by means of liquid nitrogen. The purge gas used was nitrogen. The reported values are in each case based on evaluation of the 1st heating curve since in the investigated reactive systems, changes in the sample are possible in the measuring process at high temperatures as a result of the thermal stress in the DSC. The melting temperatures Tₘ were obtained from the temperatures at the maxima of the heat flow curves. The glass transition temperature T_{g} was obtained from the temperature at half the height of a glass transition step.

Determination of Infrared Spectra

The infrared spectra were measured on a Bruker FT-IR spectrometer equipped with an ATR unit.

Starting Compounds

Polyisocyanate A1: HDI trimer (NCO functionality >3) having an NCO content of 23.0% by weight from Covestro AG. The viscosity is about 1200 mPa·s at 23° C. (DIN EN ISO 3219/A.3).

Polyisocyanate A2: PDI trimer (NCO functionality >3) having an NCO content of 21.5% by weight from Covestro AG. It has a viscosity of about 9,500 mPa·s at 23° C. (DIN EN ISO 3219/A.3).

Hexanediol diacrylate (HDDA) was obtained in a purity of 99% by weight from abcr GmbH or in a purity of ≤100% by weight from Sigma-Aldrich.

Butanediol dimethacrylate (BDDMA) was obtained in a purity of 95% by weight from Sigma Aldrich.

Hydroxypropyl methacrylate (HPMA) was obtained in a purity of 98% by weight from abcr GmbH.

Isobornyl methacrylate (IBOMA) was obtained in a purity of 100% by weight from Sigma Aldrich.

Initiator: Omnirad BL 723 (a mixture of 30-60% 2-hydroxy-2methylpropiophenone, 10-30% (2,4,6-trimethylbenzoyl)phenylphosphinic acid ethyl ester, 10-30% oligo[2-hydroxy-2-methyl-1-[4-(1-methylvinyl)phenyl] propanone]) was obtained from IGM Resins b.v.

Potassium acetate was obtained in a purity of >99% by weight from ACROS.

Polyethylene glycol (PEG) 400 was obtained in a purity of >99% by weight from ACROS.

N,N,N′-trimethylaminoethylethanolamine having an OH number of 384 mg KOH/g was obtained from Huntsman Corporation.

Zinc stearate having a zinc proportion of 10-12% was obtained from Sigma-Aldrich.

Glass fiber mat: A P-D INTERGLAS TECHNOLOGIES GmbH 90070 (US Type 1610) plain weave glass fiber mat having a weight of 82 g/m² was used.

All raw materials except for the catalyst were degassed under reduced pressure prior to use, and the polyethylene glycol was additionally dried.

Production of Catalyst K1:

The N, N, N′-trimethylaminoethylethanolamine (14.6 g) was added dropwise to the isocyanate A1 (18.3 g) with cooling and stirred until the mixture was homogeneous.

Production of Catalyst K2:

Potassium acetate (5.0 g) was stirred in the PEG 400 (95.0 g) at RT until all of it had dissolved. In this way, a 5% by weight solution of potassium acetate in PEG 400 was obtained and was used as catalyst without further treatment.

Production of the Reaction Mixture

Unless otherwise stated the polyisocyanurate composites were produced by first producing the isocyanate composition by mixing the appropriate isocyanate components (A1 or A2) with an appropriate amount of catalyst (K1-K2), initiator and acrylate at 23° C. in a Speedmixer DAC 150.1 FVZ from Hauschild at 1500 min⁻² for 120 seconds. This was then mixed with the catalyst at RT (Speedmixer).

The mixture was then transferred into a mold (metal lid, about 6 cm in diameter and about 1 cm in height) and cured in an oven.

Production of a Composite

To produce a composite the reaction mixture produced previously was knife-coated onto a siliconized PP film having a layer thickness of 100 μm. Subsequently, a glass fiber mat was placed into the reaction mixture and a further siliconized PP film was placed on top. The film sandwich is rolled with a roller and subsequently cured with a gallium- and mercury-doped lamp in a wavelength range from 200 to 380 nm at an output of 1300 mJ/cm² in an apparatus from Superfici. 25 plies of the part-cured composite are then stacked and pressed at 40 bar and 200° C. for 10 minutes in an apparatus from Wickert.

### Working Example 1

18.125 g of polyisocyanate A2, 0.750 g of catalyst K2, 0.160 g of initiator, 0.250 g of HPMA, 2.575 g of HDDA and IBOMA and 0.125 g of zinc stearate were treated according to the abovementioned production procedure for reaction mixtures. Pre-curing under UV irradiation was carried out for 2 min in an ASIGA apparatus having a DR-301C lamp to afford a rubber-like solid clear material. Curing in the oven was performed at 220° C. over 5 min to afford a solid, slightly yellowish material.

The T_{g} after UV treatment and before oven curing was −35° C. and was increased to 86° C. by the thermal curing. The thermal curing reduced the height of the characteristic NCO band between 2300 to 2250 cm⁻² by at least 80%.

### Working Example 2

19.625 g of polyisocyanate A1, 0.750 g of catalyst K2, 0.120 g of initiator, 0.175 g of HPMA, 1.875 g of HDDA and IBOMA and 0.125 g of zinc stearate were treated according to the abovementioned production procedure for reaction mixtures. Pre-curing under UV irradiation was carried out for 2 min in an ASIGA apparatus having a DR-301C lamp to afford a rubber-like clear material. Curing in the oven was performed at 220° C. over 5 min to afford a solid, slightly yellowish material.

The T_{g} after UV treatment and before oven curing was −42° C. and was increased to 61° C. by the thermal curing. The thermal curing reduced the height of the characteristic NCO band between 2300 to 2250 cm⁻¹ by at least 80%.

### Working Example 3

18.125 g of polyisocyanate A2, 0.750 g of catalyst K2, 0.160 g of initiator, 0.250 g of HPMA, 2.575 g of BDDMA and IBOMA and 0.125 g of zinc stearate were treated according to the abovementioned production procedure for reaction mixtures. Pre-curing under UV irradiation was carried out for 2 min in an ASIGA apparatus having a DR-301C lamp to afford a solid rubber-like material. Curing in the oven was performed at 220° C. over 5 min to afford a solid, slightly yellowish material.

The T_{g} after UV treatment and before oven curing was −34° C. and was increased to 86° C. by the thermal curing. The thermal curing reduced the height of the characteristic NCO band between 2300 to 2250 cm⁻¹ by 80%.

### Working Example 4

19.625 g of polyisocyanate A1, 0.750 g of catalyst K2, 0.120 g of initiator, 0.175 g of HPMA, 1.875 g of BDDMA and IBOMA and 0.125 g of zinc stearate were treated according to the abovementioned production procedure for reaction mixtures. Pre-curing under UV irradiation was carried out for 2 min in an ASIGA apparatus having a DR-301C lamp to afford a rubber-like clear material. Curing in the oven was performed at 220° C. over 5 min to afford a solid, slightly yellowish material.

The T_{g} after UV treatment and before oven curing was −40° C. and was increased to 76° C. by the thermal curing. The thermal curing reduced the height of the characteristic NCO band between 2300 to 2250 cm⁻¹ by at least 80%.

### Working Example 5

21.69 g of polyisocyanate A2, 0.75 g of catalyst K2, 0.19 g of initiator, 0.30 g of HPMA, 3.08 g of BDDMA and IBOMA and 0.15 g of zinc stearate were treated according to the abovementioned production procedure for reaction mixtures. The reaction mixture was then treated according to the abovementioned production procedure for composites. A colorless and dry composite was obtained.

### Working Example 6

22.28 g of polyisocyanate A2, 0.11 g of catalyst K1, 0.20 g of initiator, 0.31 g of HPMA, 3.17 g of BDDMA and IBOMA and 0.15 g of zinc stearate were treated according to the abovementioned production procedure for reaction mixtures. The reaction mixture was then treated according to the abovementioned production procedure for composites. A colorless and dry composite was obtained.

The T_{g} after immediate pressing was 52.5° C. Pressing after 14 days afforded a material having a T_{g} of 57.5° C. Pressing after one month afforded a material having a T_{g} of 55° C.

### Working Example 7

23.51 g of polyisocyanate A1, 0.90 g of catalyst K2, 0.14 g of initiator, 0.21 g of HPMA, 2.25 g of BDDMA and IBOMA and 0.15 g of zinc stearate were treated according to the abovementioned production procedure for reaction mixtures. The reaction mixture was then treated according to the abovementioned production procedure for composites. A colorless and dry composite was obtained.

### Working Example 8

24.14 g of polyisocyanate A1, 0.11 g of catalyst K1, 0.15 g of initiator, 0.22 g of HPMA, 2.31 g of BDDMA and IBOMA and 0.15 g of zinc stearate were treated according to the abovementioned production procedure for reaction mixtures. The reaction mixture was then treated according to the abovementioned production procedure for composites. A colorless and dry composite was obtained.

The T_{g} after immediate pressing was 57° C. Pressing after 14 days afforded a material having a T_{g} of 54° C. Pressing after one month afforded a material having a T_{g} of 49° C.

The working examples show that in a controlled two-stage reaction combination of a free-radical polymerization and a polyaddition reaction of isocyanate groups to afford a polyisocyanurate network makes it possible to produce composite materials having a high glass transition temperature and good hardness. The matrix of the semifinished product obtainable in a first step showed a rubber-like consistency. Even after several weeks of storage at room temperature and room humidity, the semifinished product could still be successfully processed into a composite material by increasing the temperature and pressing.

1. A process for producing a semifinished product, comprising:
a) wetting a fiber with a reaction mixture having a molar ratio of isocyanate groups to isocyanate-reactive groups of at least 2:1, the reaction mixture comprising
(i) an isocyanate component A;
(ii) at least one trimerization catalyst C; and
(iii) at least one component selected from the group consisting of components B, component D, and component E, wherein
component B has at least one ethylenic double bond but no isocyanate-reactive group;
component D has at least one isocyanate-reactive group and at least one ethylenic double bond in one molecule; and
component E has both at least one isocyanate group and at least one ethylenic double bond in one molecule; and
b) increasing a viscosity of the reaction mixture by at least 100% via free-radical polymerization of at least 50% of the ethylenic double bonds present in the reaction mixture.

2. The process as claimed in claim 1, wherein the fiber is present in the form of a woven fabric, a non-crimp fabric, or knitted fabric.

3. The process as claimed in claim 1, wherein the reaction mixture additionally comprises a component F which acts as an initiator for the free-radical polymerization of the ethylenic double bonds.

4. The process as claimed in claim 3, wherein the component F is activated by actinic radiation and/or the action of heat.

5. The process as claimed in claim 1, wherein a weight fraction of isocyanate groups in the reaction mixture is at least 1% and not more than 50%.

6. The process as claimed in claim 1, wherein a weight fraction of ethylenically unsaturated double bonds is at least 1% and not more than 30%.

7. The process as claimed in claim 1, wherein the molar ratio of isocyanate groups to isocyanate-reactive groups in the reaction mixture is at least 3:1 and not more than 200:1.

8. The process as claimed in claim 1, wherein ethylenically unsaturated groups without isocyanate-reactive functionality are present in the reaction mixture alongside ethylenically unsaturated groups with isocyanate-reactive functionality in a ratio of at least 1:5 and not more than 100:1.

9. The process as claimed in claim 1, wherein the reaction mixture has a modulus G′ of at least 10⁵ Pa after free-radical polymerization.

10. A semifinished product obtained by the process as claimed in claim 1.

11. A process for producing a composite material, comprising crosslinking the isocyanate groups present in the semifinished product obtained as claimed in claim 1.

12. The process as claimed in claim 11, wherein the fiber is subjected to forming before and/or during heating.

13. The process as claimed in claim 11, wherein at least 80% of free isocyanate groups present at commencement of the crosslinking are consumed during the crosslinking of the isocyanate groups.

14. The process as claimed in claim 11, wherein at least 50% of isocyanate groups originally present in the polyisocyanate component A are crosslinked to form isocyanurate groups.

15. A composite material obtained by the process as claimed in claim 11.
